(19) United States
(12) Patent Application Publication
(10) Pub. No.: US 2024/0040055 A1
(43) Pub. Date: Feb. 1, 2024

(54) IMAGE FORMING APPARATUS, NON-TRANSITORY COMPUTER READABLE MEDIUM, AND IMAGE FORMING METHOD

(71) Applicant: FUJIFILM Business Innovation Corp., Tokyo (JP)

(72) Inventors: Yushiro TANAKA, Kanagawa (JP); Seiji SHIRAKI, Kanagawa (JP); Masahiko MIZUMURA, Kanagawa (JP); Nagamasa MISU, Kanagawa (JP)

(73) Assignee: FUJIFILM Business Innovation Corp., Tokyo (JP)

(21) Appl. No.: 18/177,274

(22) Filed: Mar. 2, 2023

(30) Foreign Application Priority Data
Jul. 29, 2022 (JP) 2022-121966

(51) Int. Cl. H04N 1/38; H04N 1/23

(52) U.S. Cl. CPC H04N 1/38; H04N 1/2369

(57) ABSTRACT

An image forming apparatus includes a processor configured to: insert an unprinted page between unremoved pages in order to perform duplex printing, if a number of removed blank pages between the unremoved pages is an odd number of one or three or more on a digital file that has the blank pages removed when a document formed on duplex pages is read.

### CROSS-REFERENCE TO RELATED APPLICATIONS

This application is based on and claims priority under 35 USC 119 from Japanese Patent Application No. 2022-121966 filed Jul. 29, 2022.

### BACKGROUND

### (i) Technical Field

The present disclosure relates to an image forming apparatus, a non-transitory computer readable medium, and an image forming method.

### (ii) Related Art

Japanese Patent No. 5026465 discloses an image forming apparatus. The image forming apparatus includes an image reading device including an image reading unit enabled to read a document image of duplex pages of a document, and an image printing unit printing a document image of a digital file onto a medium. The image reading device includes a unit that determines whether a page of the read document image is a blank page or not, a unit that attaches, if the page is not a blank page, to the page, attribute information indicating the arrangement order of pages and indicating whether the page is a front or a back page, a unit that deletes the page if the page is a blank page, and a unit that creates the digital file with the blank page deleted by combining the pages. The image reading device thus creates the digital file of the read document image that is digitized on a per page basis. The image forming apparatus includes a unit that reads the attribute information on the page from the digital file created by the image reading device, a unit that determines whether attribute information on a page is present in the digital file and, if the attribute information is present, inquires about necessity of printing with the document restored with the blank page included as in the original document, and a unit that, if the inquiry results indicate that the printing with the original document restored is to be performed, performs the printing with the original document restored, using the image printing unit, in accordance with the read attribute information.

### SUMMARY

An image forming apparatus is available that reads a document with a blank page removed and prints a digital file of the read document with the removed blank document restored.

However, printing of a digital file of a document having multiple consecutive blank pages with all removed blank pages restored may lead to wasteful printing.

Aspects of non-limiting embodiments of the present disclosure relate to providing an image forming apparatus, a non-transitory computer readable medium, and an image forming method that may control wasteful printing caused by printing all blank pages.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including a processor configured to: insert an unprinted page between unremoved pages in order to perform duplex printing, if a number of removed blank pages between the unremoved pages is an odd number of one or three or more on a digital file that has the blank pages removed when a document formed on duplex pages is read.

### BRIEF DESCRIPTION OF THE DRAWINGS

Exemplary embodiment of the present disclosure will be described in detail based on the following figures, wherein:

FIG. 1 illustrates a schematic configuration of an image forming system of an exemplary embodiment of the disclosure;

FIG. 2 is a block diagram illustrating an image forming apparatus of the exemplary embodiment of the disclosure;

FIG. 3 is a flowchart illustrating an example of the flow of a process performed when the image forming apparatus of the exemplary embodiment of the disclosure reads a document;

FIG. 4 is a flowchart illustrating an example of the flow of a process performed when the image forming apparatus of the exemplary embodiment of the disclosure performs a print job;

FIGS. 5A, 5B, and 5C illustrate an operation example of reading and printing a document in accordance with the exemplary embodiment of the disclosure;

FIGS. 6A, 6B, and 6C illustrate another operation example of reading and printing the document in accordance with the exemplary embodiment of the disclosure; and

FIGS. 7A, 7B, and 7C illustrate another operation example of reading and printing the document in accordance with the exemplary embodiment of the disclosure.

### DETAILED DESCRIPTION

### Exemplary Embodiment

Exemplary embodiment of the disclosure is described below with reference to the drawings. In the drawings, the same or equivalent elements are designated with the same reference numerals. Size ratio of the drawings is exaggerated and may not be to scale.

An example of an image forming system 10 of the exemplary embodiment is described below.

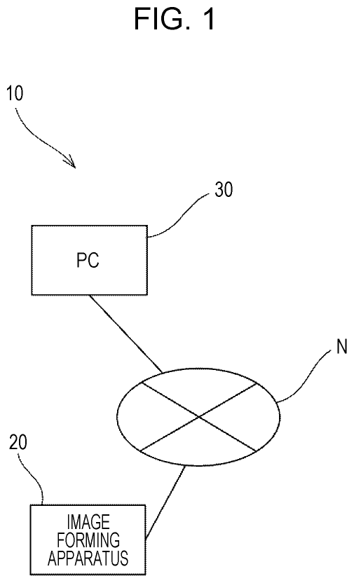

FIG. 1 illustrates the configuration of the image forming system 10 of the exemplary embodiment.

Referring to FIG. 1, an image forming apparatus 20 and a personal computer (PC) 30 are connected to each other via a network N in the image forming system 10 of the exemplary embodiment. The network N may be a local-area network (LAN), wide-area network (WAN), or the Internet. FIG. 1 illustrates one image forming apparatus 20 and one PC 30. Alternatively, multiple image forming apparatuses 20 and multiple PCs 30 may be connected to the network N.

The image forming system 10 of the exemplary embodiment is a duplex printing system. A digital file with a blank page removed may be printed when a document formed on both a front page and back page is read. Depending on the state of the digital file, the image forming system 10 performs duplex printing with an unprinted page inserted into a blank page portion. If the read document appears on facing pages, namely, a left-hand side page and a right-hand side page, and the duplex printing is performed with blank pages removed, the facing pages after being printed may fail to face each other. As a result, legibility of print results may be degraded. According to the disclosure, when the digital file with the blank page removed is printed for the document having the facing pages, printing may be performed with the facing pages still remaining facing.

The image forming apparatus 20 has a variety of functions including a print function, copy function, fax function, and scanner function.

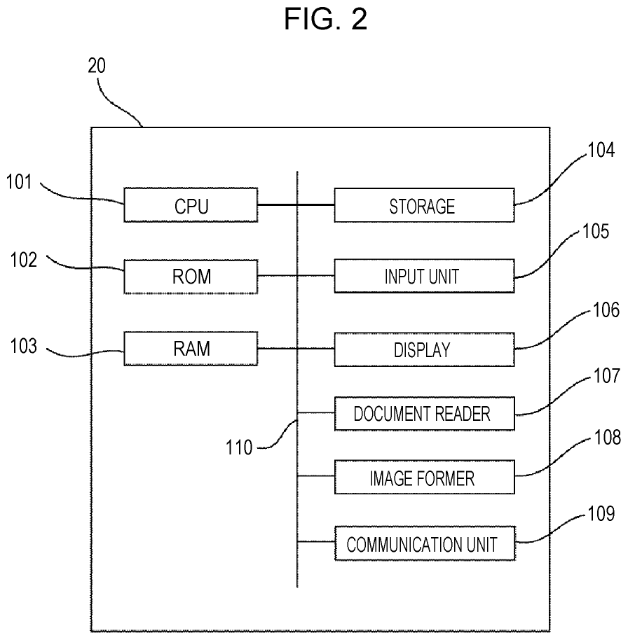

The hardware configuration of the image forming apparatuses 20 is described below. FIG. 2 is a block diagram illustrating the hardware configuration of the image forming apparatus 20 of the exemplary embodiment.

Referring to FIG. 2, the image forming apparatus 20 includes a central processing unit (CPU) 101 serving as an example of a processor, read-only memory (ROM) 102, random-access memory (RAM) 103, storage 104, input unit 105, display 106, image reader 107, image former 108, and communication unit 109. These elements are communicably connected to each other via a bus 110.

The CPU 101 executes a variety of programs and controls the elements. Specifically, the CPU 101 reads a program from the ROM 102 or the storage 104, and executes the read program using the RAM 103 as a work area. In accordance with the program stored on the ROM 102 or the storage 104, the CPU 101 controls the elements and performs a variety of arithmetic operations. In the exemplary embodiment, programs are stored on the ROM 102 or the storage 104.

The ROM 102 stores the variety of programs and variety of data. The RAM 103 operates as the work area and temporarily stores the programs or data. The storage 104 is a hard disk drive (HDD) or solid-state drive (SSD) and stores the variety of programs including an operating system and the variety of data.

The input unit 105 includes a pointing device, such as a mouse, or a keyboard and is used to enter a variety of inputs. When a document described below is read, the input unit 105 is used to remove a blank page. According to the exemplary embodiment, the display 106 is of a touch-panel type and also serve as the input unit 105.

The display 106 is, for example, a liquid-crystal display. The display 106 under the control of the CPU 101 displays a variety of information. The display 106 is of a touch-panel type and also serves as the input unit 105.

The image reader 107 picks up document sheets, one by one, placed on a paper tray of an automatic document feeder (ADF) (not illustrated) mounted in the top portion of the image forming apparatus 20 and acquires image information by optically reading the document sheets. Alternatively, the image reader 107 optically reads a document sheet placed on platen glass.

According to the exemplary embodiment, the image reader 107 includes two sensor sections (a front page reading unit and back page reading unit), each sensor section including a complementary metal oxide semiconductor (CMOS) sensor, and is enabled to read the front page and back page of a document received from the ADF (one-pass duplex reading). One sensor section may serve as a three-pass duplex reading section that permits the document to pass by three times. In response to user settings, the image reader 107 may determine in accordance with pixels of optically read image information that the document is a blank page and stores the read image as a digital file with the determined blank page removed. According to the exemplary embodiment, the digital file is stored as a portable document format (PDF) file (data in the PDF). The format of the digital file is not limited to the PDF and may be any other file format.

The image information of the document read by the image reader 107 is stored as the digital file on a storage of the PC 30 or the storage 104 of the image forming apparatus 20.

The image former 108 forms, namely, prints on a recording medium, such as a paper sheet, print data included in a print job acquired from the PC 30 via the network N or an image responsive to the image information that the image reader 107 has read.

The communication unit 109 is connected to the network N and communicates with another image forming apparatus 20, PC 30, and other devices. The communication unit 109 connects the image forming apparatus 20 to a public network and transmits to or receives from another image forming apparatus, having the fax function, image information that the image reader 107 has read.

The operation of the image forming system 10 is described below.

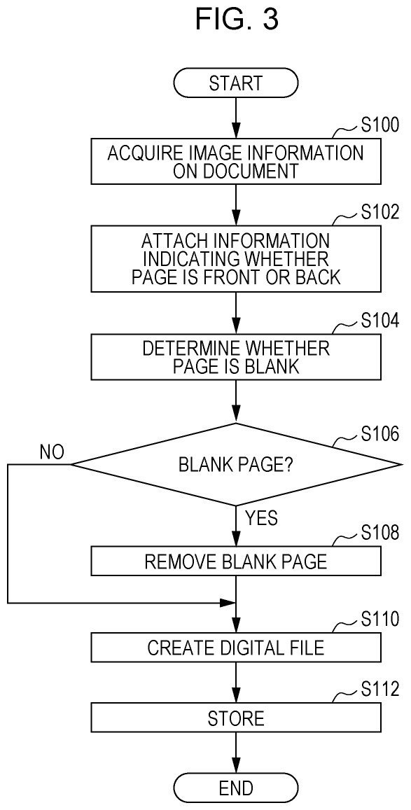

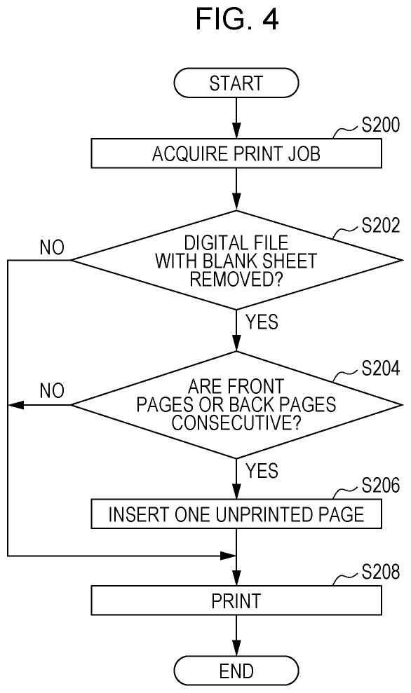

FIGS. 3 and 4 respectively illustrate the flow of a process in which the image forming apparatus 20 reads a document and the flow of a process in which the image forming apparatus 20 prints a print job. In the process described herein, the image forming apparatus 20 having the print function reads a document. Alternatively, a digital file may be created by another information forming apparatus or a scanner apparatus which reads the document. According to the exemplary embodiment, the digital file is created by the image reader 107 that reads the front page and back page of the document placed on the image reader 107. The user may validate the setting that reading is to be performed with a blank page removed.

FIG. 3 is a flowchart illustrating the flow of the process in which the image forming apparatus 20 reads the document.

In step S100, the CPU 101 reads all the front pages and back pages of the document in response to an operation of the user and acquires image information. The CPU 101 proceeds to step S102.

In step S102, the CPU 101 attaches, to the image information acquired in step S100 information, information that is related to each page of the document and indicates whether the page is a front page or a back page of the document. The information indicating whether the page is a front page or a back page of the document is stored in metadata on each page of the digital file. The CPU 101 proceeds to step S104.

In step S104, the CPU 101 determines whether the image information acquired in step S100 is a blank page or not. The determination as to whether the page is a blank page may be based on any disclosed technique. For example, if the number of black dots as pixels of an image is equal to or lower than a predetermined threshold value, the page may be determined as a blank page. The CPU 101 proceeds to step S106.

If the CPU 101 determines in step S106 that the determination in step S104 as to whether the page is a blank page indicates a blank page, the CPU 101 proceeds to step S108. If the page is not determined as a blank page, the CPU 101 proceeds to step S110 without proceeding to step S108.

In step S108, the CPU 101 removes the image information on the blank page. The CPU 101 proceeds to step S110.

In step S110, the CPU 101 creates a digital file formed through reading the document. The CPU 101 then proceeds to step S112.

In step S112, the CPU 101 causes the storage 104 to store the digital file created in step S110 or transmits the digital file created in step S110 to the PC 30 for storage.

Referring to FIG. 3, the determination as to whether the page is a blank page or not is made after the image information on all the pages of the document is acquired. The disclosure is not limited to this method. For example, the document may be read page by page and the determination as to whether the page is a blank page or not may be made each time the page is read.

FIG. 4 is a flowchart illustrating the flow of the process in which the image forming apparatus 20 prints the print job.

In step S200, the CPU 101 acquires a print job transmitted from the PC 30 in response to an operation of a user. The CPU 101 proceeds to step S202.

In step S202, the CPU 101 determines whether the print job acquired in step S200 is a digital file with a blank page removed. The determination as to whether the digital file is without the blank page is determined depending on information related to each page of the document and attached to each page of the digital file or depending on attribute information on the digital file. Specifically, if the information related to each page of the document and attached to each page of the digital file is used, and a place where information consecutive front pages or back pages is found, the digital file is determined to be with the blank page removed. If the attribute information of the digital file is used, the determination is based on whether the attribute information of the digital file includes attribute information indicating that the digital file is with the blank page removed. The determination as to whether the digital file is with the blank page removed is not limited to the method described above. The determination may be performed using another method or using a combination of the methods described above. If the digital file is determined to be with the blank page removed, the CPU 101 proceeds to step S204. If the digital file is not determined to be with the blank page removed, the CPU 101 proceeds to step S210 without proceeding to step S204.

In step S204, the CPU 101 determines whether the information of the digital file related to the document indicates that the front pages are consecutive or that the back pages are consecutive. If the front pages or the back pages are determined to be consecutive, the CPU 101 proceeds to step S206. If neither the front pages nor the back pages are determined to be consecutive, the CPU 101 proceeds to step S208 without proceeding to step S206.

In step S206, the CPU 101 inserts a blank page as an unprinted page between consecutive front pages or consecutive back pages of the print job. Specifically, an unprinted page is inserted between the pages that are not removed because of being not a blank page. The CPU 101 proceeds to step S208.

In step S208, the CPU 101 performs duplex printing for the print job. The process thus ends.

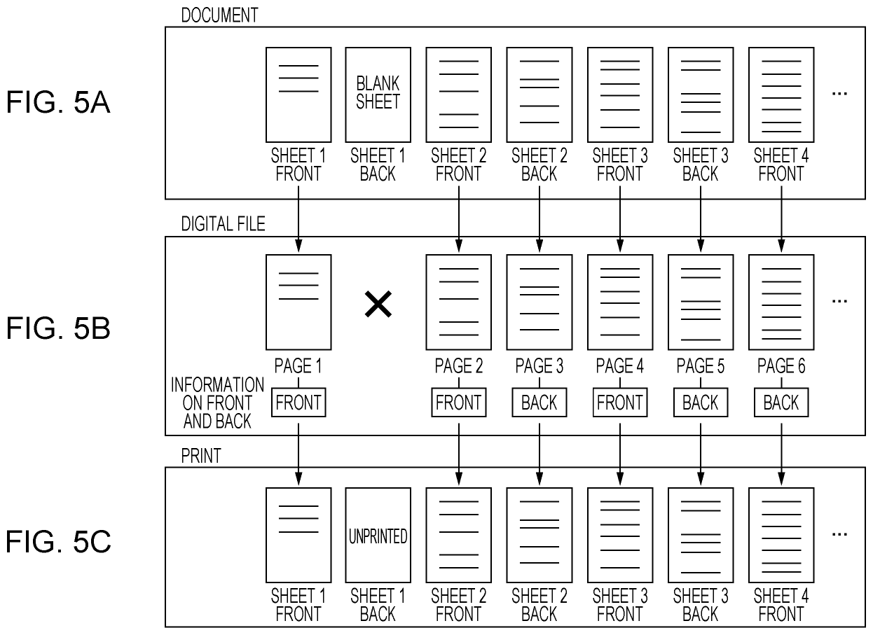

Specific examples of document reading and printing are described below with reference to FIGS. 5A through 7C.

Referring to FIGS. 5A through 5C, the number of blank pages removed is one, and the duplex printing is performed with an unprinted page inserted between unremoved pages.

FIG. 5A illustrates the state of a document. Referring to FIG. 5A, a sheet 1 back (page 2) is a blank page in the document.

FIG. 5B illustrates a digital file that is obtained by removing the blank page from the document in FIG. 5A. Referring to FIG. 5B, the digital file with the blank page removed by the image forming apparatus 20 does not have a page 1 back (page 2) as a blank page of the document and the page 2 of the digital file is a page 2 front (page 3) of the document. Each page of the digital file is attached with information indicating whether the page is a front page or back page.

FIG. 5C illustrates print results when the digital file in FIG. 5B is printed by the image forming apparatus 20. Referring to FIG. 5C, an unprinted page is inserted into the page 1 back not present in the digital file and is thus printed. The information related to the pages indicates that the pages 1 and 2 of the digital file are front pages and that the front pages are thus consecutive. For this reason, an unprinted page is inserted between the consecutive front pages and is thus printed.

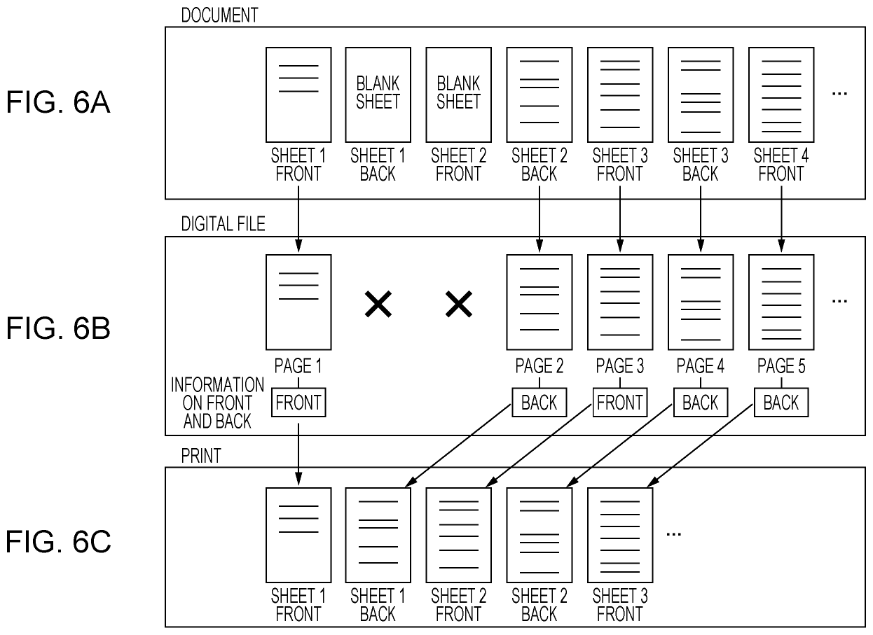

The case in which the two removed blank pages are consecutive with an unprinted page not inserted is described with reference to FIGS. 6A through 6C.

FIG. 6A illustrates the state of a document. Referring to FIG. 6A, the document includes a page 1 back (page 2) and a page 2 front (page 3) that are blank pages.

FIG. 6B illustrates the digital file obtained when the document in FIG. 6A is read by the image forming apparatus 20 with the blank pages removed. Referring to FIG. 6B, the digital file obtained when the document in FIG. 6A is read by the image forming apparatus 20 with the blank pages removed does not include the page 1 back (page 2) and page 2 front (page 3) and the page 2 of the digital file is a page 2 back (page 4) of the document. Each page of the digital file is attached with information indicating whether the page is a front page or a back page.

FIG. 6C illustrates print results obtained when the image forming apparatus 20 prints the digital file in FIG. 6B. Referring to FIG. 6C, the digital file is printed with no unprinted page inserted. Specifically, if the removed blank pages are consecutive by an even number, printing is performed with no unprinted page inserted. If information attached to each page of the digital file and indicating whether the page is a front page or a back page indicates that the front pages or the back pages are not consecutive, the removed blank pages are determined to be consecutive by an even number. In the example in FIG. 6C where the front pages or back pages are not consecutive, printing is performed with no unprinted page inserted.

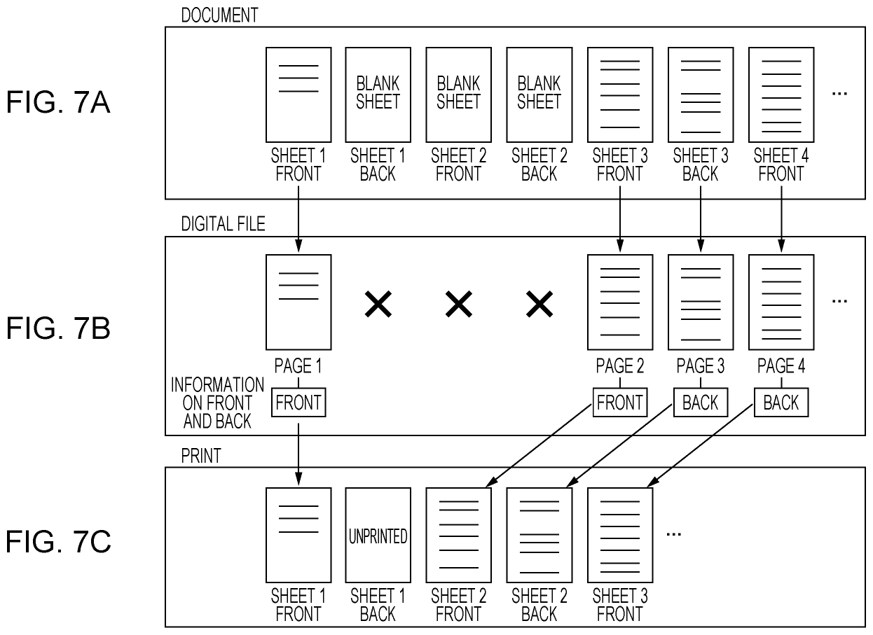

FIGS. 7A through 7C illustrate the case in which the number of removed blank pages are three and duplex printing is performed with an unprinted page inserted between unremoved pages.

FIG. 7A illustrates the state of a document. Referring to FIG. 7A, the document includes a page 1 back (page 2), page 2 front (page 3), and page 2 back (page 4) that are blank pages.

FIG. 7B illustrates the digital file that is obtained when the document in FIG. 7A is read by the image forming apparatus 20 with the blank pages removed. Referring to FIG. 7B, the digital file obtained when the document in FIG. 7A is read by the image forming apparatus 20 with the blank pages removed does not include the blank pages, namely, the page 1 back (page 2), page 2 front (page 3), and page 2 back (page 4), and the page 2 of the digital file is a page 3 front (page 5). Each page of the digital file is attached with information indicating whether the page is a front page or back page.

FIG. 7C illustrates print results obtained when the image forming apparatus 20 prints the digital file in FIG. 7B. Referring to FIG. 7C, printing is performed with an unprinted page inserted into a page 1 back that is not present in the digital file. Specifically, since the information on the pages indicates that the page 1 and page 2 of the digital file are front pages and consecutive, printing is performed with an unprinted page inserted between the consecutive front pages. Even when the removed blank pages are consecutive by an odd number equal to three or more, printing is performed with an unprinted page inserted in a similar manner as in FIGS. 5A through 5C where the number of blank pages is one.

In the case illustrated in FIGS. 5A through 5C, the number of inserted unprinted pages (one page) is equal to the number of pages of the document removed as blank pages (one page). In the case illustrated in FIGS. 7A through 7C, the number of inserted unprinted pages (one page) is different from the number of pages of the document removed as blank pages (three pages). In order to control wasteful printing, an unprinted page may be simply inserted to the extent that facing pages remain facing. If the number of unprinted pages equal to the number of pages of the document removed as blank pages are inserted, wasteful printing results.

The number of consecutive blank pages is four or more, the operation is the same as illustrated in FIGS. 6A through 7C. For example, if the number of blank pages is an even number equal to four or larger, the operation is the same as illustrated in FIGS. 6A through 6C. If the number of blank pages is an odd number equal to five or larger, the operation is the same as illustrated in FIGS. 7A through 7C. Even when the blank pages appears at multiple locations in the document, the operation is performed on the blank pages as illustrated in FIGS. 5A through 7C.

According to the exemplary embodiment, wasteful printing caused by printing all blank pages may be controlled. In particular, if the document includes facing pages, namely, a left-side page and a right-hand side page, is duplex-printed with a blank page removed, the facing pages are printed in a shifted position and appear not facing each other. This leads to less legibility. When the digital file is printed with an odd number of pages removed and the facing pages are thus printed in a shifted position because, an unprinted page may be inserted. This may control the printing of the facing pages in the shifted position. When the digital file is printed with an even number of pages removed, the facing pages are not printed in the shifted position. Printing is thus performed without inserting an unprinted page and wasteful printing may thus be controlled.

### Modifications

The present disclosure is not limited to the exemplary embodiment described above. A variety of changes and modification may be possible without departing from the scope of the disclosure.

The determination as to whether to insert an unprinted page in printing is made in accordance with the information that is attached to each page of the digital file and indicates whether the page is a front page or back page. The disclosure is not limited to this method. For example, the determination may be made in accordance with a page number or whether the page number is odd or even. If the page number is used, the determination may be made depending on whether the missing page is even or odd. If the page number is odd or even, the determination may be made whether the odd number pages or even number pages are consecutive.

According to the exemplary embodiment, the information indicating whether the page is a front page or back page of the document is stored in metadata of each page of the digital file. The storage destination of the information is not limited to the metadata. For example, the information may be stored in a header or a footer. A watermark of transparent text may be written on each page and then may be read.

According to the exemplary embodiment, programs are stored (installed) on the ROM 102 or the storage 104. Alternatively, the programs may be delivered in a recorded form on one of storage media, including a compact disk read-only memory (CD-ROM), digital versatile disk read-only memory (DVD-ROM), and universal serial bus (USB). The programs may be downloaded from an external apparatus via the network N.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image forming apparatus including:
a processor configured to:
   insert an unprinted page between unremoved pages in order to perform duplex printing, if a number of removed blank pages between the unremoved pages is an odd number of one or three or more on a digital file that has the blank pages removed when a document formed on duplex pages is read.
      (((2)))

In the image forming apparatus according to (((1))), each page of the digital file is attached with information on a page of the document.

(((3)))

In the image forming apparatus according to (((2))), the information on the page of the document indicates whether the page is a front page or a back page.

(((4)))

In the image forming apparatus according to (((3))), the processor is configured to, if front pages are consecutive or back pages are consecutive, perform the duplex printing with the unprinted page inserted between the consecutive front pages or between the consecutive back pages.

(((5)))

In the image forming apparatus according to any one of (((1))) through (((4))), the processor is configured to, if the removed blank pages are consecutive by an even number, perform the duplex printing without inserting the unprinted page.

(((6)))

In the image forming apparatus according to (((5))), the processor is configured to perform the duplex printing without inserting the unprinted page, if the information on the page of the document attached to each page of the digital file and indicating whether the page of the document is a front page or a back page indicates that the front pages are not consecutive or the back pages are not consecutive.

(((7)))

A program for performing duplex printing, the program including:
inserting an unprinted page between unremoved pages in order to perform duplex printing, if a number of removed blank pages between the unremoved pages is an odd number of one or three or more on a digital file that has the blank pages removed when a document formed on duplex pages is read.

What is claimed is:

1. An image forming apparatus comprising:
a processor configured to:
insert an unprinted page between unremoved pages in order to perform duplex printing, if a number of removed blank pages between the unremoved pages is an odd number of one or three or more on a digital file that has the blank pages removed when a document formed on duplex pages is read.

2. The image forming apparatus according to claim 1, wherein each page of the digital file is attached with information on a page of the document.

3. The image forming apparatus according to claim 2, wherein the information on the page of the document indicates whether the page is a front page or a back page.

4. The image forming apparatus according to claim 3, wherein the processor is configured to, if front pages are consecutive or back pages are consecutive, perform the duplex printing with the unprinted page inserted between the consecutive front pages or between the consecutive back pages.

5. The image forming apparatus according to claim 1, wherein the processor is configured to, if the removed blank pages are consecutive by an even number, perform the duplex printing without inserting the unprinted page.

6. The image forming apparatus according to claim 5, wherein the processor is configured to perform the duplex printing without inserting the unprinted page, if the information on the page of the document attached to each page of the digital file and indicating whether the page of the document is a front page or a back page indicates that the front pages are not consecutive or the back pages are not consecutive.

7. A non-transitory computer readable medium storing a program causing a computer to execute a process for performing duplex printing, the process comprising:
inserting an unprinted page between unremoved pages in order to perform duplex printing, if a number of removed blank pages between the unremoved pages is an odd number of one or three or more on a digital file that has the blank pages removed when a document formed on duplex pages is read.

8. An image forming method comprising:
inserting an unprinted page between unremoved pages in order to perform duplex printing, if a number of removed blank pages between the unremoved pages is an odd number of one or three or more on a digital file that has the blank pages removed when a document formed on duplex pages is read.
